(19) United States
(12) Patent Application Publication
(10) Pub. No.: US 2025/0202733 A1
(43) Pub. Date: Jun. 19, 2025

(54) PREDICTIVE RADIO INTERFERENCE MITIGATION

(71) Applicant: Cypress Semiconductor Corporation, San Jose, CA (US)

(72) Inventors: Avik Santra, Irvine, CA (US); Kiran Uln, Pleasanton, CA (US); Rakesh Taori, McKinney, TX (US)

(73) Assignee: Cypress Semiconductor Corporation, San Jose, CA (US)

(21) Appl. No.: 18/545,878

(22) Filed: Dec. 19, 2023

(51) Int. Cl. H04L 25/02; H04B 7/06; H04B 17/318; H04B 17/336; H04L 5/00; H04W 84/10

(52) U.S. Cl. CPC H04L 25/0204; H04B 7/0626; H04B 17/328; H04B 17/336; H04L 5/0012; H04W 84/10

(57) ABSTRACT

Methods and systems for predictively mitigating against radio interference. The disclosed method includes, among other things, obtaining a plurality of current channel metrics, predicting, based on the plurality of current channel metrics, a plurality of future channel metrics associated with the frequency band, and determining, based on the plurality of future channel metrics associated with the frequency band, a plurality of channel quality scores associated with the frequency band.

### TECHNICAL FIELD

This disclosure relates to wireless devices and, more specifically, to predictively mitigating against radio interference.

### BACKGROUND

Wireless networks are designed to enable communication over short distances, allowing interconnected devices, such as, Wireless Personal Area Network (WPAN) technologies, including Bluetooth® (BT), Bluetooth® Low Energy (BLE), Zigbee®, infrared, and the like, to communicate wirelessly, eliminating the need for physical cables.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIGS. 1A and 1B is a block diagram of an exemplary system configured for predictive radio interference mitigation, in accordance with implementations of the present disclosure.

FIGS. 2A-C is a block diagram of yet another exemplary system configured for predictive radio interference mitigation, in accordance with implementations of the present disclosure.

FIG. 3 depicts a flow diagram of an example method for predictive radio interference mitigation between wireless devices, in accordance with implementations of the present disclosure.

FIG. 4 depicts a flow diagram of an example method for predictive radio interference mitigation between wireless devices, in accordance with implementations of the present disclosure.

FIG. 5 depicts a flow diagram of an example method for predictive radio interference mitigation between wireless devices, in accordance with implementations of the present disclosure.

FIG. 6 is a block diagram illustrating an exemplary computer system, in accordance with implementations of the present disclosure.

### DETAILED DESCRIPTION

Aspects of the present disclosure relate to predictively mitigating against radio interference. WPAN communication operates within a principal-agent architecture where the principal WPAN device (e.g., principal device) controls the communication and the synchronization of the agent WPAN devices (e.g., agent devices). The principal device initiates the connection, defines the timing of the communication, and manages the data traffic, while the agent devices follow the principal's timing and respond to its requests, allowing for structured and efficient data exchanges between devices.

To ensure the reliability and stability of communications within a specified band (e.g., 2.4 GHz band), WPAN employs Frequency Hopping Spread Spectrum (FHSS) techniques. FHSS permits devices to intermittently alter their carrier frequencies, changing every predetermined time period (e.g., 625 us) to avoid persistent interference, which is essential in the crowded and competitive specified band where WPAN operates. The carrier frequency available for a specified band (e.g., 2.4 GHz band) includes distinct frequency channels (e.g., 79 distinct channels) defined by a universal standard (e.g., universal standard associated with Bluetooth Classic).

Hopping kernel, a defined mechanism by WPAN specification, utilizes a pseudo-random number generator to create sequences for frequency hopping, leveraging system parameters like clock and MAC address. The hopping kernel refines these sequences using an adaptive frequency hopping (AFH) channel map, determined dynamically by the principal device based on interference levels and channel quality. The AFH channel map enables WPAN devices to avoid channels prone to interference, optimizing communication reliability and performance. WPAN devices, following the sequence, selectively access the most suitable channels, maintaining stable and efficient communication even in areas with high congestion or interference.

Typically, the principal device determines and communicates the AFH channel map to the agent devices through the set AFH command. When the agent devices successfully receive the AFH channel map, both the principal and agent device adjust their communication frequencies to align with it. Typically, the universal standard defines a minimum number of channels (e.g., 20 channels) for the AFH channel map, ensuring a robust and resilient communication framework.

Typically, the AFH channel map used to maintain robust, stable, and efficient wireless connections in varying and potentially congested environments is vendor-specific. Vendors utilize varied approaches such as channel assessment algorithms or thresholds to establish the optimal AFH channel map for specific devices and environmental challenges. However, vendor-specific implementations of AFH channel maps can introduce inefficiencies, causing underutilization of viable (or available) channels due to varying criteria for channel suitability.

Aspects and embodiments of the present disclosure address these and other limitations of the existing technology by enabling systems and methods of predictively generating a channel quality score for each channel of a band. Depending on the embodiment, the channel quality score for each channel of the band may be further used to generate an AFH and, subsequently a frequency hopping sequence (FHS). More specifically, a plurality of current channel metrics are associated with channels of a band actively used for communication (e.g., active channels). A plurality of future channel metrics of active channels is predicted based on time series data associated with previous metrics of the active channel. A plurality of estimated channel metrics is obtained using channel coherency and the plurality of current metrics of the active channels for channels other than the active channels of the band (e.g., currently inactive channels). The plurality of estimated channel metrics and time series data may be used to predict a plurality of future channel metrics of the currently inactive channels. The plurality of future channel metrics of the currently active and inactive channels are used to determine a channel quality score for the band. In some embodiments, the channel quality score may be used to generate an AFH which is subsequently provided (or wirelessly transmitted) by the principal device to the agent device. Subsequently, the FHS may be generated by both the principal and agent device based on the AFH.

Depending on the embodiment, a predictive model of a plurality of predictive models, such as a machine learning module, may perform the prediction. Based on the predictive model used to perform the prediction, an identifier or weight is provided (or wirelessly transmitted) by the principal device to the agent device to select and/or update a predictive model of the agent device to perform a similar prediction as the principal device.

Aspects of the present disclosure overcome these deficiencies and others by predictively avoiding channels with interference at any given moment and exploring channels that are previously indicated as having interference to determine whether the channel is actively experiencing interference.

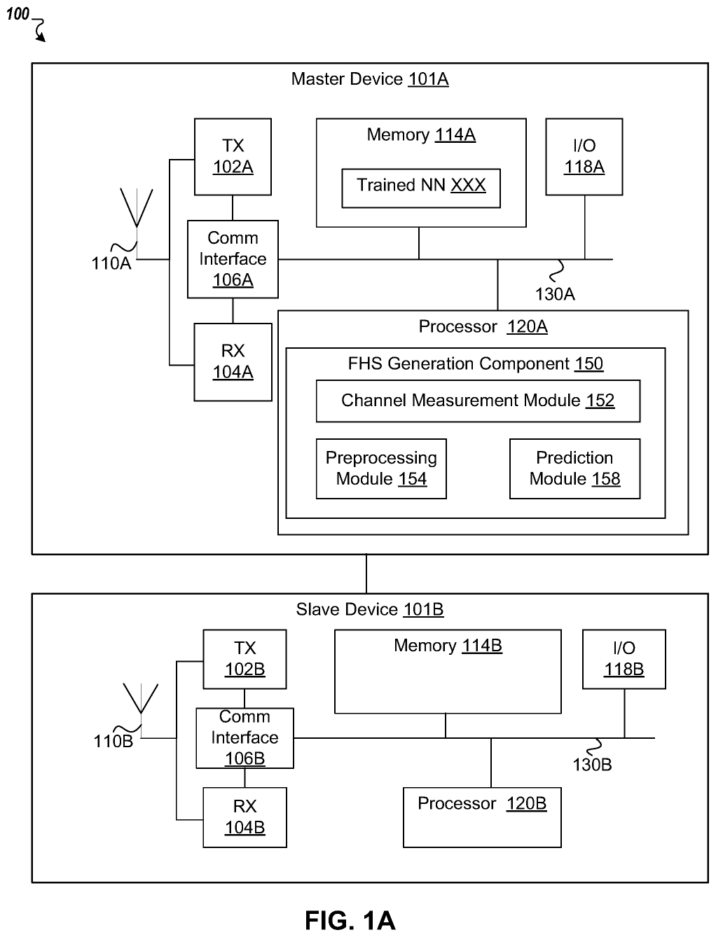

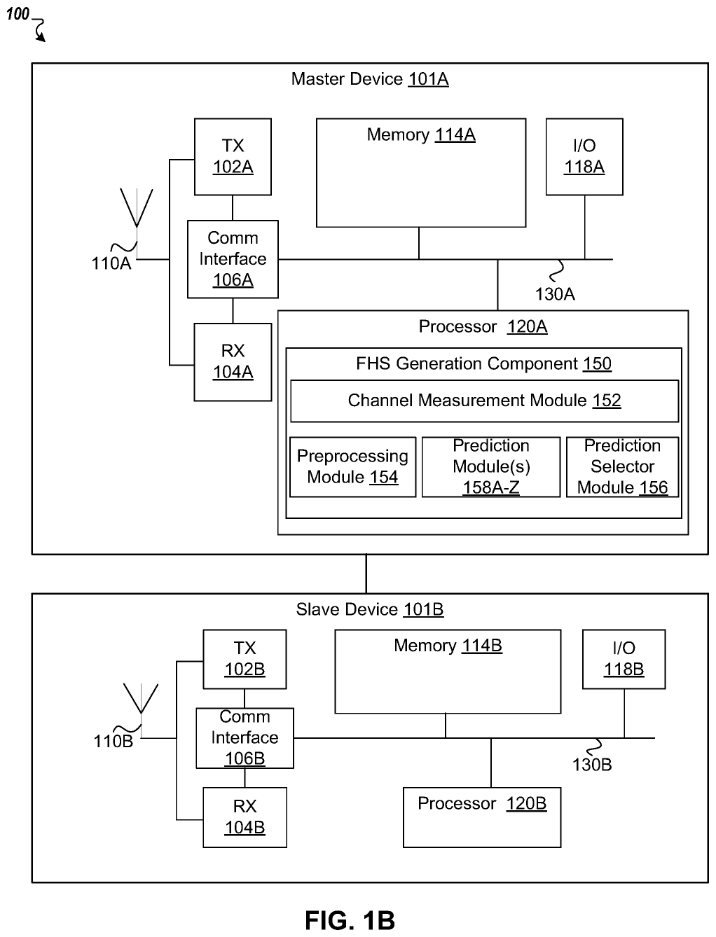

FIG. 1A is a block diagram of an exemplary system 100 configured for predictive radio interference mitigation, in accordance with implementations of the present disclosure. System 100 may include a principal device 101A and an agent device 101B communicatively coupled.

In at least some embodiments, principal device 101A includes, but is not limited to, a transmitter 102A (e.g., a PAN transmitter), a receiver 104A (e.g., a PAN receiver), a communications interface 106A, an antenna 110A coupled to the transmitter 102A and/or the receiver 104A, a memory 114A, one or more input/output (I/O) devices 118A (such as a display screen, a touch screen, a keypad, and the like), and a processor 120A. These components can all be coupled to a communications bus 130A. In some embodiments, aspects of the communication interface 106A work with the processor 120A to perform operations or functions as a processing device of the principal device 101A. In some embodiments, there is a single antenna and multiplexing logic to switch the use of the antenna between the transmitter 102A and receiver 104A. In various embodiments, frontend components such as the transmitter 102A, the receiver 104A, the communication interface 106A, and the one or more antennas (e.g., antenna 110A) described herein within various devices are adapted with or configured for WLAN and PAN-based frequency bands, e.g., Bluetooth® (BT), BLE, Wi-Fi™, Zigbee®, Z-wave™, and the like.

In at least some embodiments, agent device 101B includes, but is not limited to, a transmitter 102B (e.g., a PAN transmitter), a receiver 104B (e.g., a PAN receiver), a communications interface 106B, an antenna 110B coupled to the transmitter 102B and the receiver 104B, a memory 114B, one or more input/output (I/O) devices 118B (such as a display screen, a touch screen, a keypad, and the like), and a processor 120B. These components can all be coupled to a communications bus 130B. In some embodiments, aspects of the communication interface 106B work with the processor 120B to perform operations or functions as a processing device of the agent device 101B. In some embodiments, there is a single antenna and multiplexing logic to switch the use of the antenna between the transmitter 102B and receiver 104B. In various embodiments, frontend components such as the transmitter 102B, the receiver 104B, the communication interface 106B, and the one or more antennas (e.g., antenna 110B) described herein within various devices are adapted with or configured for WLAN and PAN-based frequency bands, e.g., Bluetooth® (BT), BLE, Wi-Fi™, Zigbee®, Z-wave™, and the like.

Principal device 101A and agent device 101B may operate within specific carrier frequencies of a band. More specifically, there may be a predetermined number of frequency channels (or plurality of channels) (e.g., 79 frequency channels) spaced apart (e.g., by 1 MHz), starting from a first frequency in a radio frequency (RF) spectrum (e.g., 2402 MHz) and going up to a second frequency in a radio frequency (RF) spectrum (e.g., 2480 MHz).

Processor 120A may further include a FHS generation component 150. FHS generation component 150 may include a channel measurement module 152, a preprocessing module 154, and a prediction module 158.

At any given point in time, a subset of channels of the band are actively used for communication (e.g., active channels). Channel measurement module 152 may obtain, at regular or irregular time intervals, a plurality of metrics for the active channels. Each plurality of metrics previously obtained at a previous time interval represents a data point in a time series data. Each metric of the plurality of metrics is a measurement of a channel of the plurality of channels of the band. Each metric may be a received signal strength indicator (RSSI), a packet error rate (PER), a channel state information (CSI), signal-to-noise Ratio (SNR), interference statistics, or any other suitable metric for determining the quality of the channel. RSSI is a metric used to measure the power level at which a device receives signals from other devices. PER is a metric used to assess the reliability and quality of communication. PER is calculated as the ratio of the number of packets received incorrectly to the total number of packets received. CSI is a metric that represents the properties and conditions of a communication channel, providing crucial information such as gain, phase shift, and delay.

In some embodiments, channel measurement module 152 may provide each plurality of metrics for the active channels to the preprocessing module 154 for preprocessing. The preprocessing module 154 preprocesses the plurality of metrics for the active channels by transforming (e.g., normalization, smoothing, differencing, etc.) and/or concatenating the plurality of metrics for the active channels to enhance quality and usability for further analysis or decision-making. Preprocessing module 154 provides the preprocessed plurality of metrics for the active channels to the prediction module 158.

Responsive to receiving a plurality of current metrics of the active channels (i.e., a plurality of metrics for the active channel at a current time interval) and the time series data, the prediction module 158 predicts a plurality of metrics of the active channels for a future time interval (e.g., the next time interval). More specifically, prediction module 158 may identify long-term trends of interference based on the time series data associated with the active channels while considering the plurality of current metrics of the active channels to account for short-term interference. Thus, prediction module 158, based on the long-term trends of interference and short-term interferences, predicts the plurality of metrics of the active channels for the future time interval.

Prediction module 158 may estimate, using channel coherency and the plurality of current metrics of the active channels, metrics for channels other than the active channels of the band (e.g., currently inactive channels). Channel coherency refers to the degree of stability and predictability in a wireless communication channel over time and frequency. It describes how consistent or correlated the channel's properties, such as gain, phase, and delay, remain with respect to changes in time and frequency. Coherence bandwidth represents the range of frequencies over which the channel's characteristics remain relatively consistent or correlated.

For example, if one frequency component within the coherence bandwidth experiences a certain type of variation in channel properties, other frequency components within that same coherence bandwidth are likely to experience similar variations. It signifies a level of consistency in how the channel behaves across different frequencies within the coherence bandwidth. A larger coherence bandwidth means that the channel exhibits consistent behavior over a wider range of frequencies, while a smaller coherence bandwidth implies more rapid variations with frequency. In other words, depending on the level of coherence bandwidth, metrics associated with a channel may correlate to one or more channels within the coherence bandwidth (e.g., neighboring channels).

Prediction module 158, for each of currently inactive channels, identifies neighboring channels of a respective currently inactive channel. The neighboring channels of the respective currently inactive channel may include channels of the active channels. Based on the metrics associated with the neighboring channels of the respective currently inactive channel, prediction module 158 estimates a metric for the respective currently inactive channel. Thus, prediction module 158 generates a plurality of estimated metrics of the currently inactive channels.

Prediction module 158 predicts a plurality of metrics of the currently inactive channels for the future time interval (e.g., the next time interval). Prediction module 158 may identify long-term trends of interference based on the time series data associated with the currently inactive channels while considering the plurality of estimated metrics of the currently inactive channels to account for short-term interference. Thus, prediction module 158, based on the long-term trends of interference and short-term interferences associated with the currently inactive channels, predict the plurality of metrics of the currently inactive channels.

The plurality of metrics of the active channels and the predicted plurality of metrics of the currently inactive channels predicted for the future time interval by the prediction module 158 may be combined to produce a plurality of predicted metrics for all channels of the band (e.g., a plurality of predict metrics for the band).

Depending on the embodiment, prediction module 158 may be a predictive function, such as Kalman Filter, or a recurrent neural network (RNN), such as a Long Short-Term Memory (LSTM) or Temporal Convolutional Network (TCN) to identify long-term trends of interference and short-term interferences for active and inactive channels to generate the plurality of predicted metrics for the band.

Prediction module 158 may determine, based on the plurality of predicted metrics for the band, a plurality of channel quality scores associated with the band. Each channel quality score of the plurality of channel quality scores corresponds to a channel of the band. Channel quality score typically refers to a metric or numerical value that assesses the quality or performance of a channel (e.g., how well data can be transmitted through the channel). The channel quality score of a channel may be correlated to the (predicted) metric of the channel. For example, a metric, such as RSSI, is inversely proportional to the channel quality score because as the signal gets weaker (lower RSSI), the channel quality score tends to improve. This is because weaker signals are more susceptible to noise and interference, which can degrade the quality of the communication channel. In another example, a metric, such as PER, is inversely proportional to the channel quality score because as the probability of errors in the received packets decreases (lower PER), the channel quality score tends to improve.

Principal device 101A, based on its assessment of the plurality of channel quality scores generated by the prediction module 158, decides the AFH channel map, indicating which channels should be used for communication. For example, channels that should be used for communication may include channels in which their corresponding channel quality score does not exceed a predetermined threshold value. Once the AFH channel map is decided, FHS generation component 150 of the principal device 101A may provide, via an AFH command, the AFH channel map to the agent device 101B. Thus, the principal device 101A and the agent device 101B may independently generate an FHS in view of an FHS definition which specifies the order in which a principal device 101A and agent device 101B should hop across the AFH channel map.

With reference to FIG. 1B, instead of the FHS generation component 150 including a single prediction module (e.g., prediction module 158), the FHS generation component 150 includes a plurality of prediction modules (e.g., prediction modules 158A-Z) and a prediction selector module 156.

Responsive to receiving a plurality of current metrics of the active channels (e.g., a plurality of metrics for the active channel at a current time interval) and the time series data, the prediction selector module 156 assesses the plurality of current metrics of the active channels and the time series data to select a prediction module of the plurality of prediction modules (e.g., prediction modules 158A-Z). Each prediction module of the plurality of prediction modules is configured to predict metrics for all channels of the band and may be optimized in view of either: (i) the date and/or time of the transmission, (ii) the data rate requirements of the transmission, (iii) the proximity between the wireless device (e.g., between principal and agent devices), (iv) the prediction strategy (e.g., exploitative prediction or explorative prediction), or any other suitable transmission based or predictive based scenario.

Data rate requirement refers to the amount of digital data that a user needs to transmit or receive per unit of time, typically measured in bits per second (bps) or its multiples (e.g., Mbps, Gbps). Proximity between wireless devices may be determined based on an overall assessment of the metrics (e.g., RSSI) across all channels of the band. Exploitative prediction exploits known patterns that maximize throughput. Explorative prediction introduces a degree of randomness to discover better channels of the band over time.

Accordingly, the selected prediction module performs tasks similar to prediction module 158 of FIG. 1. Such as, predicting the plurality of metrics of the active channels for the future time interval based on the long-term trends of interference and short-term interferences; predicting a plurality of metrics of the currently inactive channels for the future time interval based on the long-term trends of interference and short-term interferences associated with the currently inactive channels; and determining, based on the plurality of predicted metrics for the band, a plurality of channel quality scores associated with the band.

Depending on the embodiment, each of the prediction modules 158A-Z may be a predictive function, such as Kalman Filter, or a recurrent neural network (RNN), such as a Long Short-Term Memory (LSTM) or Temporal Convolutional Network (TCN) to identify long-term trends of interference and short-term interferences for active and inactive channels to generate the plurality of predicted metrics for the band.

Principal device 101A, based on its assessment of the plurality of channel quality scores generated by the selected prediction module (e.g., prediction modules 158C), decides the AFH channel map, indicating which channels should be used for communication. For example, channels that should be used for communication may include channels in which their corresponding channel quality score does not exceed a predetermined threshold value. Once the AFH channel map is decided, FHS generation component 150 of the principal device 101A may provide, via an AFH command, the AFH channel map to the agent device 101B. Thus, the principal device 101A and the agent device 101B may independently generate an FHS in view of an FHS definition which specifies the order in which a principal device 101A and agent device 101B should hop across the AFH channel map.

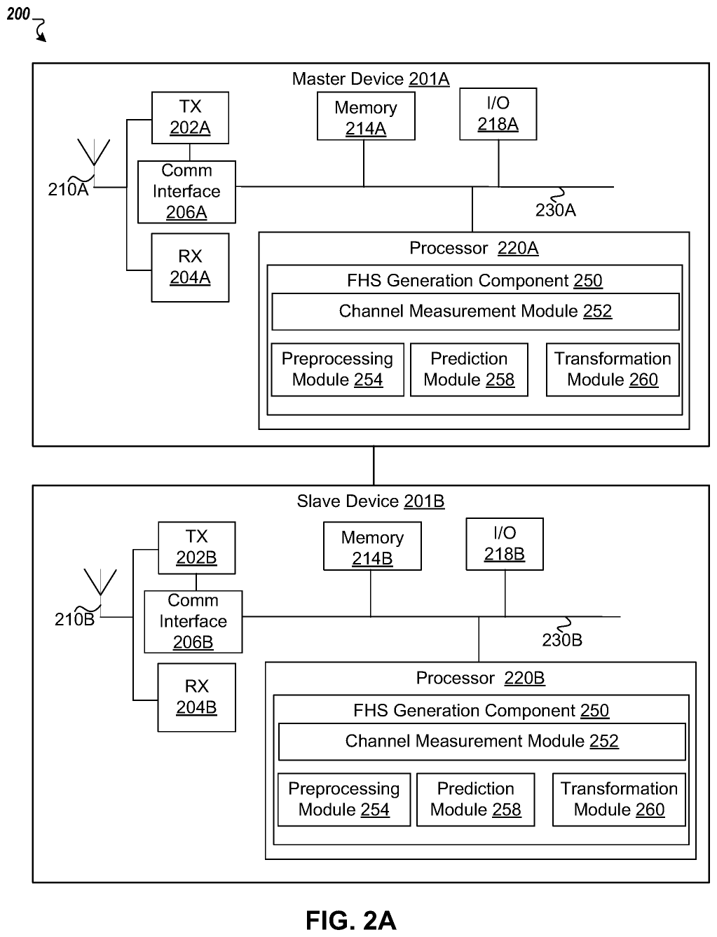

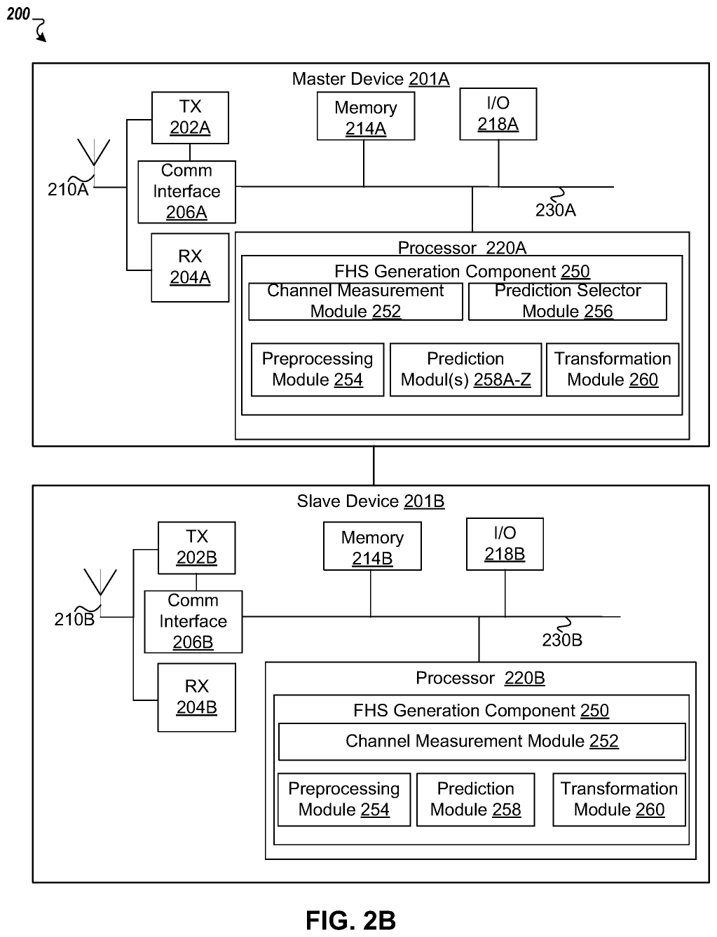

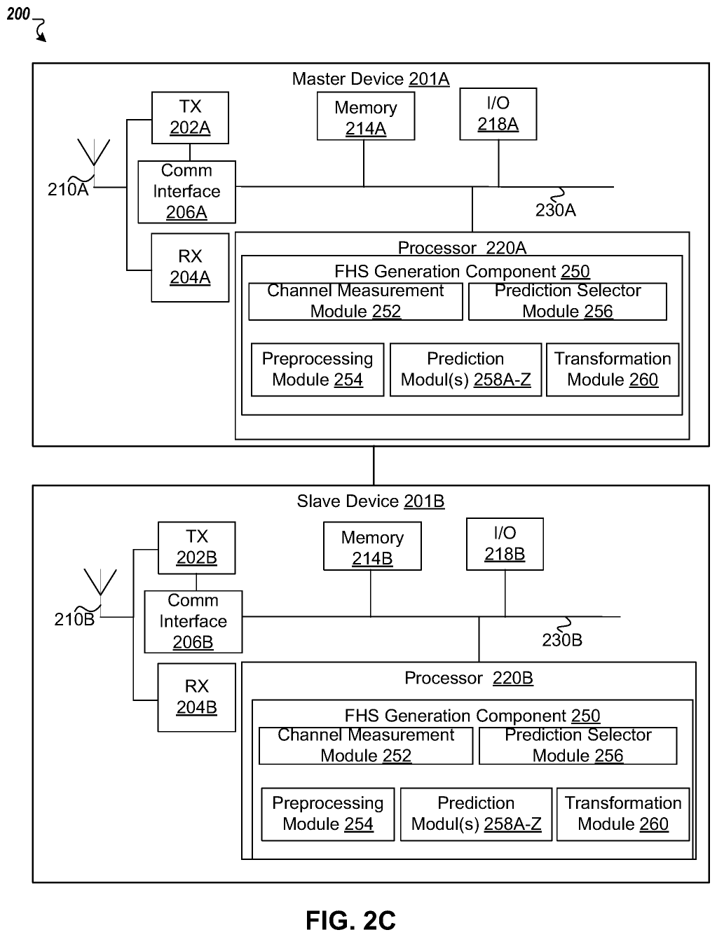

FIG. 2A is a block diagram of an exemplary system 200 configured for predictive radio interference mitigation, in accordance with implementations of the present disclosure. System 200 may include a principal device 201A and an agent device 201B communicatively coupled.

In at least some embodiments, principal device 201A includes, but is not limited to, a transmitter 202A (e.g., a PAN transmitter), a receiver 204A (e.g., a PAN receiver), a communications interface 206A, an antenna 210A coupled to the transmitter 202A and the receiver 204A, a memory 214A, one or more input/output (I/O) devices 218A (such as a display screen, a touch screen, a keypad, and the like), and a processor 220A. These components can all be coupled to a communications bus 230A. In some embodiments, aspects of the communication interface 206A work with the processor 220A to perform operations or functions as a processing device of the principal device 201A. In some embodiments, there is a single antenna and multiplexing logic to switch the use of the antenna between the transmitter 202A and receiver 204A. In various embodiments, frontend components such as the transmitter 202A, the receiver 204A, the communication interface 206A, and the one or more antennas (e.g., antenna 210A) described herein within various devices are adapted with or configured for WLAN and PAN-based frequency bands, e.g., Bluetooth® (BT), BLE, Wi-Fi™, Zigbee®, Z-wave™, and the like.

In at least some embodiments, agent device 201B includes, but is not limited to, a transmitter 202B (e.g., a PAN transmitter), a receiver 204B (e.g., a PAN receiver), a communications interface 206B, an antenna 210B coupled to the transmitter 202B and the receiver 204B, a memory 214B, one or more input/output (I/O) devices 218B (such as a display screen, a touch screen, a keypad, and the like), and a processor 220B. These components can all be coupled to a communications bus 230B. In some embodiments, aspects of the communication interface 206B work with the processor 220B to perform operations or functions as a processing device of the agent device 201B. In some embodiments, there is a single antenna and multiplexing logic to switch the use of the antenna between the transmitter 202B and receiver 204B. In various embodiments, frontend components such as the transmitter 202B, the receiver 204B, the communication interface 206B, and the one or more antennas (e.g., antenna 210B) described herein within various devices are adapted with or configured for WLAN and PAN-based frequency bands, e.g., Bluetooth® (BT), BLE, Wi-Fi™, Zigbee®, Z-wave™, and the like.

Principal device 201A and agent device 201B may operate within specific carrier frequencies of a band. More specifically, there may be a predetermined number of frequency channels (or plurality of channels) (e.g., 79 frequency channels) spaced apart (e.g., by 1 MHz), starting from a first frequency in a radio frequency (RF) spectrum (e.g., 2402 MHz) and going up to a second frequency in a radio frequency (RF) spectrum (e.g., 2480 MHz).

Processor 220A and processor 220B may further include a FHS generation component 250. FHS generation component 250 may include a channel measurement module 252, a preprocessing module 254, a prediction module 258, and a transformation module 260.

At any given point in time, a subset of channels of the band are actively used for communication (e.g., active channels). Channel measurement module 252 of the principal device 201A may obtain, at regular or irregular time intervals, a plurality of metrics for the active channels. In some embodiments, channel measurement module 252 of the principal device 201A may provide each plurality of metrics for the active channels to the preprocessing module 254 of the principal device 201A for preprocessing. Preprocessing module 254 of the principal device 201A provides the prediction module 258 of the principal device 201A with the preprocessed plurality of metrics for the active channels.

Prediction module 258 of the principal device 201A, similar to prediction module 158 of FIG. 1, predicts the plurality of metrics of the active channels for the future time interval based on the long-term trends of interference and short-term interferences. Prediction module 258 of the principal device 201A, similar to prediction module 158 of FIG. 1, predicts a plurality of metrics of the currently inactive channels for the future time interval based on the long-term trends of interference and short-term interferences associated with the currently inactive channels. Prediction module 258 of the principal device 201A, similar to prediction module 158 of FIG. 1, determines, based on the plurality of predicted metrics for the band, a plurality of channel quality scores associated with the band.

Prediction module 258 of the principal device 201A, based on the plurality of channel quality scores associated with the band, selects good channels of the band for the AFH channel using a threshold (e.g., desired channels). Prediction module 258 of the principal device 201A, during obtaining of the plurality of current metrics of the active channels, receives an FHS used during a time interval prior to the current time interval (e.g., a previous FHS). Prediction module 258 of the principal device 201A identifies channels of the band not used in the previous FHS (e.g., previously unused channels). Prediction module 258 of the principal device 201A identifies a subset of channels of the previously unused channels not included in the desired channels (e.g., stale channels). Depending on the embodiment, predictive module 258 of the principal device 201A may further reduce channels included in the stale channels based on a channel blacklist which includes channels that are prohibited. The channel blacklist may be received (or obtained) with the previous FHS.

Prediction module 258 of the principal device 201A randomly selects a predetermined number of channels from the stale channels (e.g., randomly selected stale channels). Prediction module 258 of the principal device 201A randomly selects the predetermined number of channels from the desired channels (e.g., randomly selected desired channels). Prediction module 258 of the principal device 201A replaces the randomly selected desired channels with the randomly selected stale channels. Thus, one or more good channels included in the desired channels are replaced with previously unused channels.

Prediction module 258 of the principal device 201A generates an AFH channel map using the desired channels. Prediction module 258 of the principal device 201A provides the AFH channel map to the transformation module 260 of the principal device 201A. Transformation module 260 of the principal device 201A generates, using an FHS definition, an FHS based on the AFH channel map.

Prior to, during, or after the performance of the prediction module 258 of the principal device 201A, the principal device 201A may cause the prediction module 258 of the agent device 201B to perform the same tasks as prediction module 258 of principal device 201A. The prediction module 258 of the principal device 201A is identical to the prediction module 258 of the agent device 201B. Thus, as a result of the prediction module 258 of the agent device 201B performing the same tasks as the prediction module 258 of the principal device 201A, both the principal device 201A and agent device 201B generates the same FHS.

With reference to FIG. 2B, instead of the FHS generation component 250 of the principal device 201A including a single prediction module (e.g., prediction module 258), the FHS generation component 250 includes a plurality of prediction modules (e.g., prediction modules 258A-Z) and a prediction selector module 256.

Responsive to receiving a plurality of current metrics of the active channels (e.g., a plurality of metrics for the active channel at a current time interval) and the time series data, the prediction selector module 256 assesses the plurality of current metrics of the active channels and the time series data to select a prediction module of the plurality of prediction modules (e.g., prediction modules 258A-Z). Each prediction module of the plurality of prediction modules are configured to predict metrics for all channels of the band and is optimized in view of either: (i) the date and/or time of the transmission, (ii) the data rate requirements of the transmission, (iii) the proximity between the wireless device (e.g., between principal and agent devices), (iv) the prediction strategy (e.g., exploitative prediction or explorative prediction), or any other suitable transmission based or predictive based scenario.

Prediction selector module 256 of the principal device 201A identifies weights (or parameters) associated with the selected prediction module. Prediction selector module 256 of the principal device 201A provides the weights associated with the selected prediction module to the agent device 201B. Responsive to the agent device 201B receiving weights, FHS generation component 250 of the agent device 201B updates the prediction module 258 of the agent device 201B in view of the received weights. For example, each weight of the prediction module 258 of the agent device 201B is replaced with a weight of the received weights. Accordingly, the prediction module 258 of the agent device 201B is updated to be identical to the prediction module 258 of the principal device 201A. Thus, as a result, the prediction module 258 of the agent device 201B and the prediction module 258 of the principal device 201A, similar to prediction module 258 of the principal device 201A of FIG. 2A, may generate the same AFH channel map which is ultimately used to generate matching FHS.

With reference to FIG. 2C, instead of the FHS generation component 250 of the principal device 201A and the agent device 201B including a single prediction module (e.g., prediction module 258), the FHS generation component 250 of the principal device 201A and the agent device 201B includes a plurality of prediction modules (e.g., prediction modules 258A-Z) and a prediction selector module 256.

Responsive to receiving a plurality of current metrics of the active channels (e.g., a plurality of metrics for the active channel at a current time interval) and the time series data, the prediction selector module 256 assesses the plurality of current metrics of the active channels and the time series data to select a prediction module of the plurality of prediction modules (e.g., prediction modules 258A-Z). Each prediction module of the plurality of prediction modules are configured to predict metrics for all channels of the band and is optimized in view of either: (i) the date and/or time of the transmission, (ii) the data rate requirements of the transmission, (iii) the proximity between the wireless device (e.g., between principal and agent devices), (iv) the prediction strategy (e.g., exploitative prediction or explorative prediction), or any other suitable transmission based or predictive based scenario.

Prediction selector module 256 of the principal device 201A obtains an identifier associated with the selected prediction module. More specifically, the plurality of prediction module 258A-Z of the principal device 201A is identical to the plurality of prediction module 258A-Z of the agent device 201B. Each prediction module of the plurality of prediction module 258A-Z of the principal device 201A and the matching prediction module of the plurality of prediction module 258A-Z of the agent device 201B are assigned the same unique identifier. Thus, an identifier identifying a prediction module of the principal device 201A may be used to identify a matching prediction module of the agent device 201B.

Prediction selector module 256 of the principal device 201A provides the identifier associated with the selected prediction module to the agent device 201B. In some embodiments, the prediction selector module 256 of the principal device 201A may provide the identifier to the agent device 201B via an AFH command. Prediction selector module 256 of the agent device 201B identifies a prediction module of the plurality of prediction modules of the agent device 201B with the identifier. Thus, the prediction selector module 256 of the principal device 101A and the agent device 101B select the same prediction module of the plurality of prediction modules. Thus, as a result, the selected prediction module of the principal device 201A and the agent device 201B, similar to the prediction module 258 of the principal device 201A of FIG. 2A, may generate the same AFH channel map which is ultimately used to generate matching FHS.

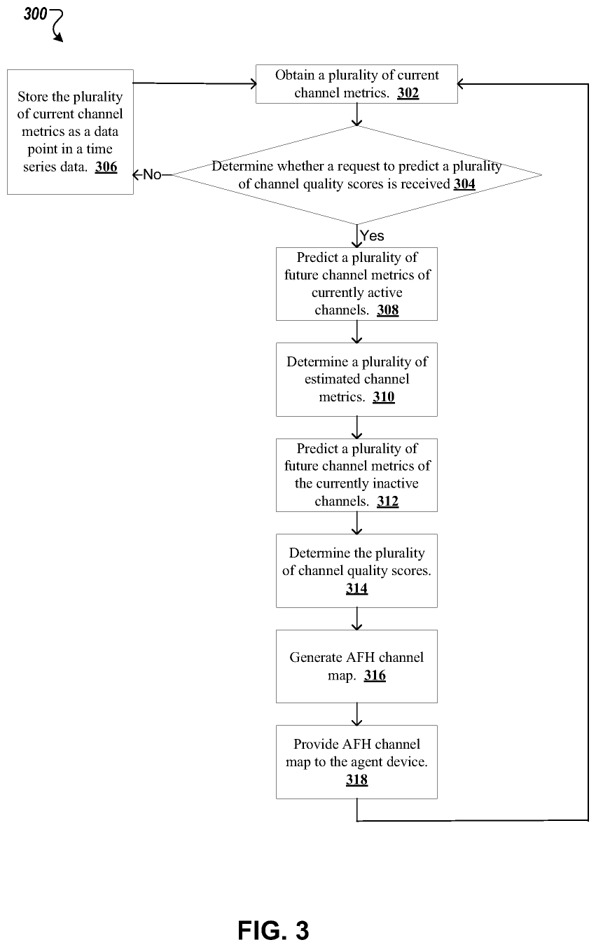

FIG. 3 depicts a flow diagram of an example method 300 for predictive radio interference mitigation, in accordance with implementations of the present disclosure. Method 300 can be performed by processing logic that can include hardware (circuitry, dedicated logic, etc.), software (e.g., instructions run on a processing device), or a combination thereof. In one implementation, some, or all of the operations of method 300 can be performed by one or more components of system 100 of FIGS. 1A and 1B or system 200 of FIGS. 2A-C. In some embodiments, some, or all of the operations of method 300 can be performed by FHS generation component 150 of FIGS. 1A and 1B or FHS generation component 250 of FIGS. 2A-C, as described above.

At block 302, the processing logic obtains a plurality of current channel metrics. As previously described, at any given point in time, a subset of channels of a band are actively used for communication (e.g., active channels). Accordingly, the plurality of current channel metrics corresponds to active channels (e.g., the plurality of current metrics of the active channels).

At block 304, the processing logic determines whether a request to predict a plurality of channel quality scores is received. Responsive to not receiving the request, the processing logic proceeds to block 306 at stores the plurality of current channel metrics as a data point in a time series data. The processing logic proceeds to block 302. Responsive to receiving the request, the processing logic proceeds to block 308.

At block 308, the processing logic predicts a plurality of future channel metrics of currently active channels. As previously described, the plurality of current metrics of the active channels and the time series data is used to predict the plurality of future channel metrics of currently active channels.

At block 310, the processing logic determines a plurality of estimated channel metrics. As previously described, using channel coherency and the plurality of current metrics of the active channels for channels other than the active channels of the band (e.g., currently inactive channels) may be estimated (e.g., the plurality of estimated channel metrics).

At block 312, the processing logic predicts a plurality of future channel metrics of the currently inactive channels. As previously described, similar to the plurality of current metrics of the active channels, the plurality of estimated channel metrics and the time series data are used to predict the plurality of future channel metrics of the currently inactive channels.

At block 314, the processing logic determines the plurality of channel quality scores. As previously described, the plurality of future channel metrics of the currently inactive channels and the plurality of current metrics of the active channels are combined into the plurality of future channel metrics of the band. The plurality of future channel metrics of the band is used to determine the plurality of channel quality scores.

At block 316, the processing logic generates AFH channel map. More specifically, based on the assessment of the plurality of channel quality scores the AFH channel map indicating which channels should be used for communication is decided. At block 318, the processing logic provides AFH channel map to the agent device. The AFH channel map may be provided via an AFH command. The processing logic proceeds to block 302.

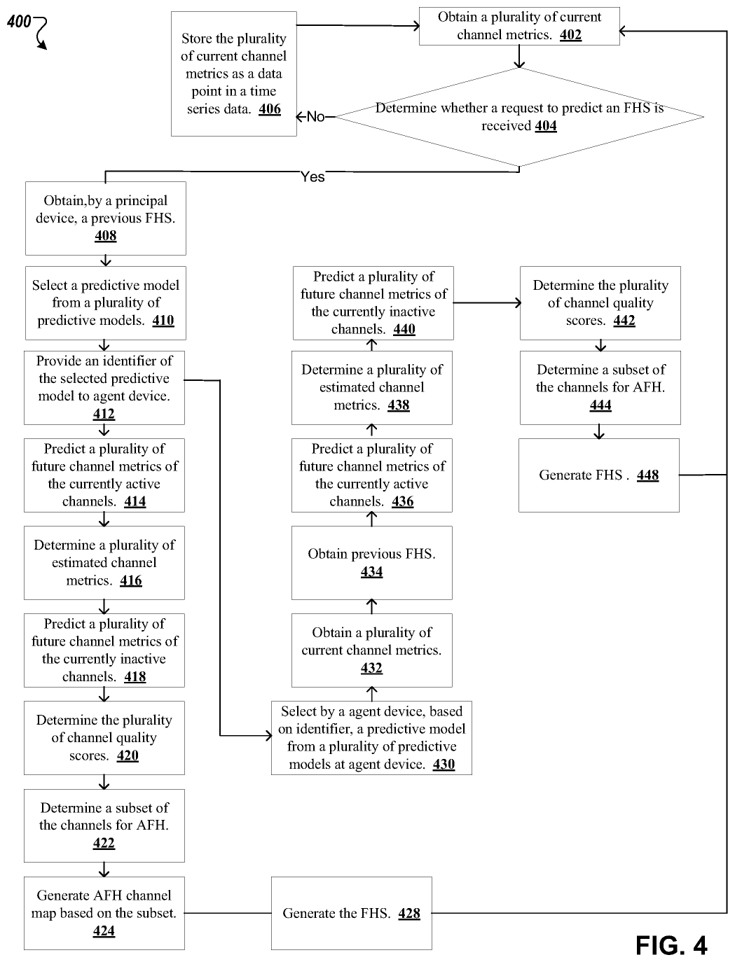

FIG. 4 depicts a flow diagram of an example method 400 for predictive radio interference mitigation, in accordance with implementations of the present disclosure. Method 400 can be performed by processing logic that can include hardware (circuitry, dedicated logic, etc.), software (e.g., instructions run on a processing device), or a combination thereof. In one implementation, some, or all of the operations of method 400 can be performed by one or more components of system 100 of FIGS. 1A and 1B or system 200 of FIGS. 2A-C. In some embodiments, some, or all of the operations of method 400 can be performed by FHS generation component 150 of FIGS. 1A and 1B or FHS generation component 250 of FIGS. 2A-C, as described above.

At block 402, the processing logic obtains a plurality of current channel metrics. As previously described, at any given point in time, a subset of channels of a band are actively used for communication (e.g., active channels). Accordingly, the plurality of current channel metrics corresponds to active channels (e.g., the plurality of current metrics of the active channels).

At block 404, the processing logic determines whether a request to predict an FHS is received. Responsive to not receiving the request, the processing logic proceeds to block 406 and stores the plurality of current channel metrics as a data point in a time series data. The processing logic proceeds to block 302. Responsive to receiving the request, the processing logic proceeds to block 408.

At block 408, the processing logic obtains a previous FHS. More specifically, an FHS used during a time interval prior to the current time interval.

At block 410, the processing logic selects a predictive model from a plurality of predictive models. As previously described, the plurality of current metrics of the active channels and the time series data is assessed to select a prediction model. Each prediction model is configured to predict metrics for all channels of the band and is optimized in view of either: (i) the date and/or time of the transmission, (ii) the data rate requirements of the transmission, (iii) the proximity between the wireless device (e.g., between principal and agent devices), (iv) the prediction strategy (e.g., exploitative prediction or explorative prediction), or any other suitable transmission based or predictive based scenario.

At block 412, the processing logic provides an identifier of the selected predictive model to agent device. As previously described, both the principal and agent device includes identical prediction models which are commonly assigned the same unique identifier. Thus, an identifier identifying a prediction model of the principal may be used to identify a matching prediction model of the agent.

At block 414, the processing logic predicts a plurality of future channel metrics of the currently active channels. As previously described, the plurality of current metrics of the active channels and the time series data is used to predict the plurality of future channel metrics of currently active channels.

At block 416, the processing logic determines a plurality of estimated channel metrics. As previously described, using channel coherency and the plurality of current metrics of the active channels for channels other than the active channels of the band (e.g., currently inactive channels) may be estimated (e.g., the plurality of estimated channel metrics).

At block 418, the processing logic predicts a plurality of future channel metrics of the currently inactive channels. As previously described, similar to the plurality of current metrics of the active channels, the plurality of estimated channel metrics and the time series data are used to predict the plurality of future channel metrics of the currently inactive channels.

At block 420, the processing logic determines the plurality of channel quality scores. As previously described, the plurality of future channel metrics of the currently inactive channels and the plurality of current metrics of the active channels are combined into the plurality of future channel metrics of the band. The plurality of future channel metrics of the band is used to determine the plurality of channel quality scores.

At block 422, the processing logic determines a subset of the channels for AFH. As previously described, the subset is determined by selecting good channels of the band using a threshold (e.g., desired channels) and randomly replacing the desired channels with previously unused channels not included in the desired channels (e.g., stale channels) identified from the previous FHS. At block 424, the processing logic generates AFH channel map based on the subset. At block 428, the processing logic generates the FHS using an FHS definition and the AFH channel map.

At block 430, responsive to receiving the identifier of the selected predictive model from the principal device, the processing logic selects, based on identifier, a predictive model from a plurality of predictive models at agent device. At block 432, the processing logic, similar to block 402, obtain a plurality of current channel metrics. At block 434, similar to block 408, the processing logic obtains previous FHS. At block 436, similar to block 414, the processing logic predicts a plurality of future channel metrics of the currently active channels.

At block 438, similar to block 416, the processing logic determines a plurality of estimated channel metrics. At block 440, similar to block 418, the processing logic predicts a plurality of future channel metrics of the currently inactive channels. At block 442, similar to block 420, the processing logic determines the plurality of channel quality scores. At block 444, similar to block 422, the processing logic determines a subset of the channels for AFH. At block 448, similar to block 428, the processing logic generate FHS and proceeds to block 402.

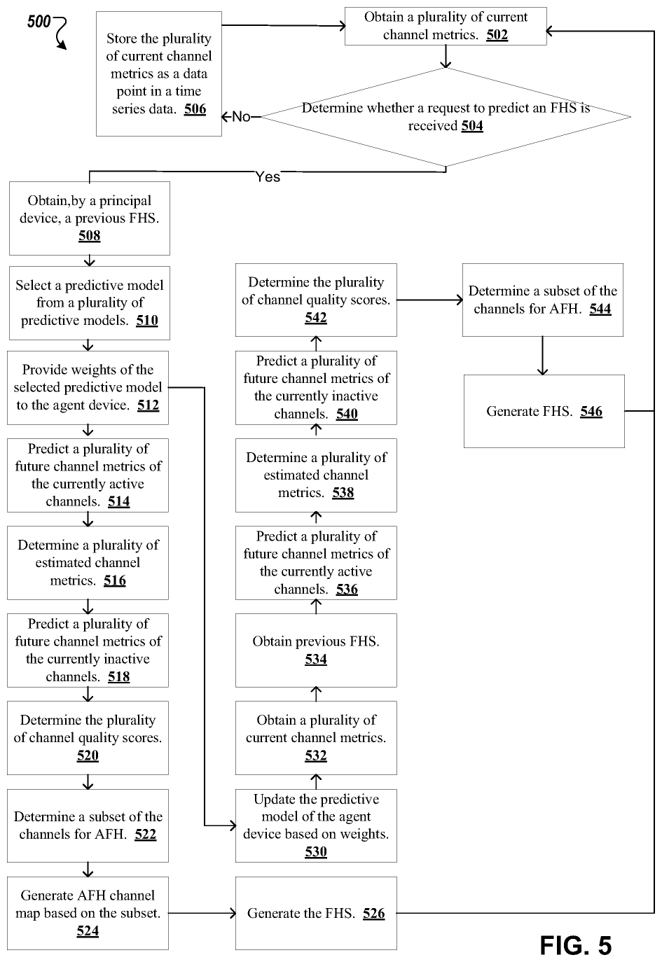

FIG. 5 depicts a flow diagram of an example method 500 for predictive radio interference mitigation, in accordance with implementations of the present disclosure. Method 500 can be performed by processing logic that can include hardware (circuitry, dedicated logic, etc.), software (e.g., instructions run on a processing device), or a combination thereof. In one implementation, some, or all of the operations of method 500 can be performed by one or more components of system 100 of FIGS. 1A and 1B or system 200 of FIGS. 2A-C. In some embodiments, some, or all of the operations of method 500 can be performed by FHS generation component 150 of FIGS. 1A and 1B or FHS generation component 250 of FIGS. 2A-C, as described above.

At block 502, the processing logic obtains a plurality of current channel metrics. As previously described, at any given point in time, a subset of channels of a band are actively used for communication (e.g., active channels). Accordingly, the plurality of current channel metrics corresponds to active channels (e.g., the plurality of current metrics of the active channels).

At block 504, the processing logic determines whether a request to predict a FHS is received. Responsive to not receiving the request, the processing logic proceeds to block 506. Responsive to receiving the request, the processing logic proceeds to block 508.

At block 506, the processing logic stores the plurality of current channel metrics as a data point in a time series data. Responsive to storing the plurality of current channel metrics, the processing logic proceeds to block 502.

At block 508, the processing logic obtain previous FHS. More specifically, an FHS used during a time interval prior to the current time interval.

At block 510, the processing logic selects a predictive model from a plurality of predictive models. As previously described, the plurality of current metrics of the active channels and the time series data is assessed to select a prediction model. Each prediction model is configured to predict metrics for all channels of the band and is optimized in view of either: (i) the date and/or time of the transmission, (ii) the data rate requirements of the transmission, (iii) the proximity between the wireless device (e.g., between principal and agent devices), (iv) the prediction strategy (e.g., exploitative prediction or explorative prediction), or any other suitable transmission based or predictive based scenario.

At block 512, the processing logic provides weights of the selected predictive model to the agent device. As previously described, while the principal device may include a plurality of predictive models, the agent device may include a single predictive model. Accordingly, weights associated with a selected predictive model is provided to the agent device in order for the agent device to update the single predictive model to match the selected predictive model of the principal device.

At block 514, the processing logic predicts a plurality of future channel metrics of the currently active channels. As previously described, the plurality of current metrics of the active channels and the time series data is used to predict the plurality of future channel metrics of currently active channels.

At block 516, the processing logic determines a plurality of estimated channel metrics. As previously described, using channel coherency and the plurality of current metrics of the active channels for channels other than the active channels of the band (e.g., currently inactive channels) may be estimated (e.g., the plurality of estimated channel metrics).

At block 518, the processing logic predicts a plurality of future channel metrics of the currently inactive channels. As previously described, similar to the plurality of current metrics of the active channels, the plurality of estimated channel metrics and the time series data are used to predict the plurality of future channel metrics of the currently inactive channels.

At block 520, the processing logic determines the plurality of channel quality scores. As previously described, the plurality of future channel metrics of the currently inactive channels and the plurality of current metrics of the active channels are combined into the plurality of future channel metrics of the band. The plurality of future channel metrics of the band is used to determine the plurality of channel quality scores.

At block 522, the processing logic determines a subset of the channels for AFH. As previously described, the subset is determined by selecting good channels of the band using a threshold (e.g., desired channels) and randomly replacing the desired channels with previously unused channels not included in the desired channels (e.g., stale channels) identified from the previous FHS. At block 524, the processing logic generates AFH channel map based on the subset. At block 526, the processing logic generates FHS. The processing logic proceeds to block 502.

At block 530, responsive to receiving weights of the selected predictive model from the principal device, the processing logic updates the predictive model of the agent device based on weights. As previously described, each weight of the predictive model of the agent device is replaced with a weight of the received weights. Thus, the predictive model of the agent device is updated to be identical to the selected predictive model of the principal device and as a result, may generate the same AFH channel map ultimately used to generate matching FHS.

At block 532, similar to block 502, the processing logic obtains the plurality of current channel metrics. At block 534, similar to block 508, the processing logic obtains a previous FHS. At block 540, similar to block 514, the processing logic predicts a plurality of future channel metrics of the currently active channels. At block 536, similar to block 516, the processing logic determines a plurality of estimated channel metrics. At block 538, similar to block 518, the processing logic predicts a plurality of future channel metrics of the currently inactive channels. At block 542, similar to block 520, the processing logic determines the plurality of channel quality scores. At block 544, similar to block 522, the processing logic determines a subset of the channels for AFH. At block 546, similar to block 526, the processing logic generates FHS and proceeds to block 502.

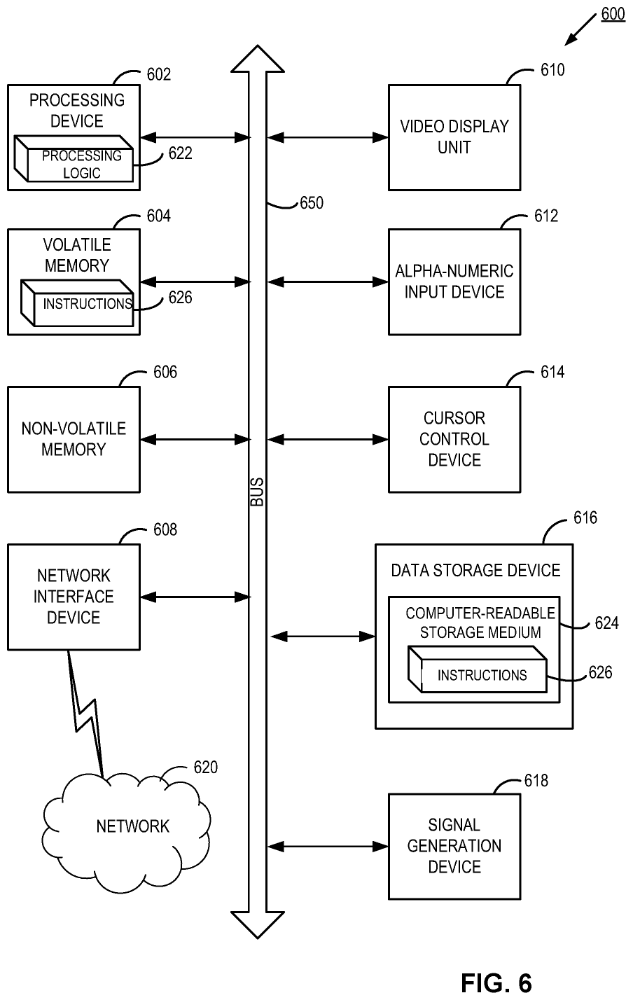

FIG. 6 is a block diagram illustrating an exemplary computer system 600, in accordance with implementations of the present disclosure. The computer system 600 can correspond to processor 120A, processor 120B, processor 220A, and processor 220B, described with respect to FIGS. 1A and 1B and FIGS. 2A-C. Computer system 600 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processing device (processor) 602, a main memory 604 (e.g., read-only memory (ROM), flash memory, dynamic random access memory (DRAM) such as synchronous DRAM (SDRAM), double data rate (DDR SDRAM), or DRAM (RDRAM), etc.), a static memory 606 (e.g., flash memory, static random access memory (SRAM), etc.), and a data storage device 616, which communicate with each other via a bus 650.

Processor (processing device) 602 represents one or more general-purpose processing devices such as a microprocessor, central processing unit, or the like. Processor 602 includes a processing logic 622. More particularly, the processor 602 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 can also be one or more special-purpose processing devices such as an application-specific integrated circuit (ASIC), a field programmable gate array (FPGA), a digital signal processor (DSP), a network processor, or the like. The processor 602 is configured to execute instructions 626 (e.g., for predictive radio interference mitigation) for performing the operations discussed herein.

The computer system 600 can further include a network interface device 608. The computer system 600 also can include a video display unit 610 (e.g., a liquid crystal display (LCD) or a cathode ray tube (CRT)), an input device 612 (e.g., a keyboard, an alphanumeric keyboard, a motion sensing input device, touch screen), a cursor control device 614 (e.g., a mouse), and a signal generation device 618 (e.g., a speaker).

The data storage device 616 can include a non-transitory machine-readable storage medium 624 (also computer-readable storage medium) on which is stored one or more sets of instructions 626 (e.g., for predictive radio interference mitigation) embodying any one or more of the methodologies or functions described herein. The instructions can also reside, completely or at least partially, within the main memory 604 and/or within the processor 602 during execution thereof by the computer system 600, the main memory 604 and the processor 602 also constituting machine-readable storage media. The instructions can further be transmitted or received over a network 620 via the network interface device 608.

In one implementation, the instructions 626 include instructions for predictive radio interference mitigation. While the computer-readable storage medium 624 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, refer to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer-readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include a collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
obtaining, by a principal wireless personal area network (WPAN) device, a plurality of current channel metrics, wherein each current channel metric of the plurality of current channel metrics corresponds to a currently active channel of a frequency band for the principal WPAN device;
predicting, based on the plurality of current channel metrics, a plurality of future channel metrics of the currently active channels for the principal WPAN device;
estimating, based on the plurality of current channel metrics, a plurality of estimated channel metrics, wherein each estimated channel metric of the plurality of estimated channel metrics corresponds to a currently inactive channel of the frequency band for the principal WPAN device;
predicting, based on the plurality of estimated channel metrics, a plurality of future channel metrics of the currently inactive channels for the principal WPAN device; and
determining, based on the plurality of future channel metrics of the currently active channels and the plurality of future channel metrics of the currently inactive channels, a plurality of channel quality scores.

2. The method of claim 1, further comprising:
generating, based on the plurality of channel quality scores, an adaptive frequency hopping (AFH) channel map comprising a subset of a plurality of channels of the frequency band used to determine a frequency hopping sequence (FHS) for the principal WPAN device.

3. The method of claim 1, wherein each of the plurality of channel metrics is one of: a received signal strength characteristic (RSSI), a packet error rate (PER), a channel state information (CSI), a signal-to-noise Ratio (SNR), or interference statistics.

4. The method of claim 2, further comprising:
transmitting, by the principal WPAN device, the AFH channel map to an agent WPAN device for use in determining a matching FHS.

5. The method of claim 1, wherein the predicting of the plurality of future channel metrics of the currently active channels, the estimating of the plurality of estimated channel metrics, and the predicting of the plurality of future channel metrics of the currently inactive channels are performed by a predictive model.

6. The method of claim 1, wherein the predicting of the plurality of future channel metrics of the currently active channels, the estimating of the plurality of estimated channel metrics, and the predicting of the plurality of future channel metrics of the currently inactive channels are performed by a predictive model of a plurality of predictive models selected prior to predicting the plurality of future channel metrics of the currently active channels for the principal WPAN device.

7. A wireless device, comprising:
a FHS generation component comprising:
a channel measurement module configured to:
obtain a plurality of current channel metrics, wherein each current channel metric of the plurality of current channel metrics corresponds to a currently active channel of a frequency band for the wireless device; and
a prediction module configured to:
predict, based on the plurality of current channel metrics, a plurality of future channel metrics of the currently active channels for the wireless device;
estimate, based on the plurality of current channel metrics, a plurality of estimated channel metrics, wherein each estimated channel metric of the plurality of estimated channel metrics corresponds to a currently inactive channel of the frequency band for the wireless device;
predict, based on the plurality of estimated channel metrics, a plurality of future channel metrics of the currently inactive channels for the wireless device; and
determine, based on the plurality of future channel metrics of the currently active channels and the plurality of future channel metrics of the currently inactive channels, a plurality of channel quality scores.

8. The wireless device of claim 7, wherein the FHS generation component further comprises:
a prediction selector module configured to identify, using the plurality of current channel metrics, weights associated with a predictive model used by the prediction module to predict the plurality of future channel metrics of the currently active channels, estimate the plurality of estimated channel metrics, and predict the plurality of future channel metrics of the currently inactive channels.

9. The wireless device of claim 8, wherein the prediction selector module is further configured to wirelessly transmit to another wireless device the weights for generating a matching FHS.

10. The wireless device of claim 7, wherein the FHS generation component further comprises:
a prediction selector module configured to:
identify, based on the plurality of channel quality scores, a subset of a plurality of channels of the frequency band; and
generate, based on the subset of the plurality of channels of the frequency band, an AFH channel map; and
a transformation module configured to:
determine, based on the AFH channel map, an FHS for the wireless device.

11. The wireless device of claim 7, wherein the prediction module is further configured to:
obtain a previous FHS during obtaining the plurality of current channel metrics;
identify, based on the plurality of channel quality scores and the previous FHS, a subset of a plurality of channels of the frequency band;
generate, based on the subset of the plurality of channels of the frequency band, an AFH channel map; and
determining, based on the AFH channel map, an FHS for the wireless device.

12. The wireless device of claim 7, wherein each of the plurality of channel metrics is one of: a received signal strength characteristic (RSSI), a packet error rate (PER), a channel state information (CSI), a signal-to-noise Ratio (SNR), or interference statistics.

13. The wireless device of claim 7, wherein the predicting of the plurality of future channel metrics of the currently active channels, the estimating of the plurality of estimated channel metrics, and the predicting of the plurality of future channel metrics of the currently inactive channels are performed by a predictive model of a plurality of predictive models selected in response to obtaining the plurality of current channel metrics.

14. The wireless device of claim 13, wherein the FHS generation component further comprises:
a prediction selector module configured to:
wirelessly transmit to another wireless device an identifier associated with the selected predictive model to select a corresponding predictive model of a plurality of predictive models of the another wireless device for generating a matching FHS.

15. A system comprising:
a first WPAN device comprising a processing device,
and a second WPAN device in communication with the first WPAN device, wherein the processing device of the first WPAN device is perform operations comprising:
obtaining a plurality of current channel metrics, wherein each current channel metric of the plurality of current channel metrics corresponds to a currently active channel of a frequency band for the first WPAN device;
predicting, based on the plurality of current channel metrics, a plurality of future channel metrics associated with the frequency band; and
determining, based on the plurality of future channel metrics associated with the frequency band, a plurality of channel quality scores associated with the frequency band.

16. The system of claim 15, wherein each channel metric of the plurality of channel metrics is one of: received signal strength characteristic (RSSI), packet error rate (PER), a channel state information (CSI), a signal-to-noise Ratio (SNR), or interference statistics.

17. The system of claim 15, wherein predicting, based on the plurality of current channel metrics, the plurality of future channel metrics associated with the frequency band comprises:
predicting, based on the plurality of current channel metrics, a plurality of future channel metrics of the currently active channels for the first WPAN device;
estimating, based on the plurality of current channel metrics, a plurality of estimated channel metrics, wherein each estimated channel metric of the plurality of estimated channel metrics corresponds to a currently inactive channel of the frequency band for the first WPAN device;
predicting, based on the plurality of estimated channel metrics, a plurality of future channel metrics of the currently inactive channels for the first WPAN device; and
aggregating the plurality of future channel metrics of the currently active channels for the first WPAN device and the plurality of future channel metrics of the currently inactive channels for the first WPAN device into the plurality of future channel metrics associated with the frequency band.

18. The system of claim 15, wherein the processing device of the first WPAN device is to perform operations further comprising:
identifying, based on the plurality of channel quality scores, a subset of a plurality of channels of the frequency band;
generating, based on the subset of the plurality of channels of the frequency band, an AFH channel map; and
determining, based on the AFH channel map, an FHS for the first WPAN device.

19. The system of claim 18, wherein identifying, based on the plurality of channel quality scores, the subset of the plurality of channels of the frequency band comprises adjusting the identified subset of the plurality of channels of the frequency band based on the plurality of channel quality scores to replace one or more channels of the subset with one or more channels not included in a previous FHS for the first WPAN device.

20. The system of claim 15, wherein the processing device of the first WPAN device is perform operations further comprising transmitting, based on a predictive model used to predict the plurality of future channel metrics associated with the frequency band, one of: weights associated with the predictive model used by the first WPAN device or a unique identifier associated with the predictive model used by the first WPAN device to the second WPAN device to be used by the second WPAN to predict the plurality of future channel metrics associated with the frequency band and subsequently a FHS for the second WPAN device matching a FHS for the first WPAN device.
